(19) United States
(12) Patent Application Publication
(10) Pub. No.: US 2012/0242946 A1
(43) Pub. Date: Sep. 27, 2012

(54) LIQUID CRYSTAL DISPLAY DEVICE AND METHOD FOR MANUFACTURING SAME

(75) Inventor: Masatoshi Itoh, Osaka (JP)

(73) Assignee: SHARP KABUSHIKI KAISHA, Osaka (JP)

(21) Appl. No.: 13/514,382

(22) PCT Filed: Sep. 22, 2010
(86) PCT No.: PCT/JP2010/005747

§ 371 Date: Jun. 7, 2012

(30) Foreign Application Priority Data
Dec. 8, 2009 (JP) 2009-278539

(51) Int. Cl. G02F 1/1339

(52) U.S. Cl. 349/153; 349/190

(57) ABSTRACT

The present invention is a liquid crystal display device that includes the following: a first substrate 10 and a second substrate 20 that are disposed to face each other and that have alignment films 15 and 25 provided on the surfaces facing each other, respectively; a sealing member 30 that is located between outer peripheral portions of the first substrate 10 and the second substrate 20 to attach the outer peripheral portions to each other and that forms a hermetically sealed space inside; and a liquid crystal layer encapsulated in the hermetically sealed space. The outer peripheral edges of the alignment films 15 and 25 on the first substrate 10 and the second substrate 20 are located inside the outer peripheral edges of the substrates 10 and 20. In the outer peripheral portion of at least one of the alignment films 15 and 25, notches 15a or 25a are formed. The sealing member 30 is configured to straddle the substrates 10 and 20 and the alignment films 15 and 25, thereby covering the notches 15a and 25a.

### TECHNICAL FIELD

The present invention relates to a liquid crystal display device and to a manufacturing method thereof.

### BACKGROUND ART

A liquid crystal display device has a configuration in which a pair of substrates facing each other are attached to each other through a sealing member in a frame shape in which a liquid crystal layer is encapsulated. In the liquid crystal display device, liquid crystal molecules between the pair of substrates are set to be in a prescribed orientation state. The orientation state of the liquid crystal molecules is changed by applying a prescribed voltage to the liquid crystal layer to adjust transmittance of light between the pair of substrates in order to perform desired display.

Orientation control of the liquid crystal molecules between the pair of substrates is performed by alignment films that are respectively formed on surfaces on the liquid crystal layer side of the respective substrates. The respective alignment films are formed of an organic material such as polyimide resin or the like, for example. The adhesion strength of these alignment films with respect to a sealing member that is formed of epoxy resin or the like, for example, is not very high, and they tend to repel the sealing member. Because of this, when the entire sealing member is formed on the surfaces of the alignment films, there is a risk of the pair of substrates detaching from each other due to a mechanical stress during a later process step or when the product is in use or the like.

Therefore, there has been known an arrangement in which the alignment films and the sealing member are disposed separately from each other. Patent Document 1 discloses a print control pattern formed of a protruded structure, a recessed structure, or the like that is disposed between the sealing member and a display region, for example. Further, according to this configuration, it is possible to prevent an alignment material from soaking and spreading. Because of this, Patent Document 1 explains that it becomes easier to pattern the edges of the alignment films and that it is possible to prevent the alignment films from being formed under a sealing location. Patent Document 1 also explains that it is possible to decrease the distance between the sealing member and the display region.

### RELATED ART DOCUMENTS

### Patent Documents

Patent Document 1: Japanese Patent Application Laid-Open Publication No. 2007-114586

### SUMMARY OF THE INVENTION

### Problems to be Solved by the Invention

However, when disposing the sealing member and the alignment films separately from each other as described above, if a foreign substance attached to a substrate surface when the substrate was formed remains at an exposed portion between the sealing member and the alignment film, the foreign substance may float into the liquid crystal layer after the pair of substrates are attached to each other to form the liquid crystal layer. During an alignment treatment such as rubbing or the like after forming the alignment films, cleaning, and the like, the foreign substance in the exposed portion may be attached to the alignment film. Because of this, there are risks of problems in orientation control of the liquid crystal molecules and problems in image display such as a bright spot, a display stain, uneven display, and the like caused by the foreign substance.

Thus, disposing a portion of the sealing member so as to overlap the alignment films can be suggested in order to prevent the foreign substance left on the substrate surface from floating into the liquid crystal layer without exposing the substrate surface between the sealing member and the alignment films. However, the adhesion strength between the sealing member and the alignment films is not very high as described above. Because of this, the larger the overlapping areas between the sealing member and the alignment films are, the lower the adhesion strength between the sealing member and the substrates becomes. However, if the overlapping areas between the sealing member and the alignment films are reduced, it becomes difficult to control the overlapping portions. Particularly, in a liquid crystal display device having a narrow frame configuration in which a frame region, which is also a non-display region where the sealing member can be formed, is small, it is very difficult to control the overlapping portions because the width of the sealing member is also narrow.

The present invention seeks to address these issues, and its object is to prevent a foreign substance attached to a substrate surface from floating into a liquid crystal layer and to secure sufficiently high adhesion strength between a sealing member and substrates.

### Means for Solving the Problems

In order to achieve the objects described above, in the present invention, the manner in which the sealing member and the alignment films overlap each other is improved so that the adhesion strength between the sealing member and the substrates is not adversely affected.

Specifically, the present invention applies to a liquid crystal display device having a first substrate and a second substrate that are disposed to face each other and that have alignment films formed on their surfaces facing each other, respectively, a sealing member that is located between outer peripheral portions of the first substrate and the second substrate to attach the outer peripheral portions to each other and that forms a hermetically sealed space inside, and a liquid crystal layer that is encapsulated in the hermetically sealed space. The present invention uses the following means for solving the problems.

In a first invention, outer peripheral edges of the alignment films on the first substrate and the second substrate are located inside outer peripheral edges of the substrates, and a notch or an opening is formed in an outer peripheral portion of at least one of the alignment films. The sealing member straddles the substrates and the alignment films to cover the notch or the opening.

According to the configuration above, the sealing member partially overlaps the alignment films. Because of this, surfaces of the first substrate and the second substrate are not exposed between the sealing member and the alignment films. Even if foreign substances attached to the substrates when the substrates were manufactured are left on the surfaces of the respective substrates, it is possible to prevent the foreign substances from floating into the liquid crystal layer. Furthermore, because the notch or the opening is formed in a portion of the alignment films that overlaps with the sealing member, the overlapping area between the sealing member and the alignment films is reduced by this amount. Furthermore, the contact areas between the sealing member and the substrate surfaces increase corresponding to the area of the sealing member that is in contact with the substrate surfaces through the notch or the opening. As a result, the adhesion strength between the sealing member and the substrates is improved. Therefore, it is possible to prevent the foreign substances attached to the substrate surfaces from floating into the liquid crystal layer and to secure sufficiently high adhesion strength between the sealing member and the substrates.

Furthermore, even if the alignment film having the notch and the opening or the sealing member is formed at a location that is shifted from the location where it was to be formed, the overlapping area of the alignment film with respect to the entire sealing member can be within a prescribed area range that can secure the necessary adhesion strength between the sealing member and the substrates. Therefore, a margin (margin area) of the alignment film formation location is increased, and it is also possible to stabilize the quality of the liquid crystal display device having a narrow frame configuration.

A second invention is the liquid crystal display device according to the first invention, wherein the notch or the opening is formed in the outer peripheral portions of both of the alignment films.

According to the configuration above, it is possible to secure sufficiently high adhesion strength in both the first substrate and the second substrate, as well as in the sealing member. Because of this, it is possible to achieve a liquid crystal display device in which these substrates are attached to each other in a secure manner.

A third invention is the liquid crystal display device according to the first or second invention, wherein the overlapping area of the alignment film having the notch or the opening and the sealing member is an area that is 30% or less of the entire area of the sealing member.

According to the configuration above, an area portion of at least 70% or more of the entire sealing member is formed directly on substrate surface. Because of this, when a portion of the sealing member overlaps the alignment films, it is possible to secure the adhesion strength to be as high as possible between the sealing member and the substrates.

It would be difficult to achieve this structure by making the widths of the overlapping portions narrower because it would be difficult to control the overlapping portions of the sealing member and the alignment films in such a structure. However, according to the present invention, the contact areas between the sealing member and the substrate surfaces are increased through the notch or the opening formed in the alignment films. As a result, the configuration can be achieved in a simple manner while securing relatively large overlapping portions of the sealing member and the alignment films.

A fourth invention is the liquid crystal display device according to any one of the first to third inventions, wherein an organic film that is exposed from the alignment film in an outer peripheral portion is provided on a liquid crystal layer side in at least one of the first substrate and the second substrate, and wherein the sealing member is formed so as to cover the organic film portion exposed from the alignment film.

According to the configuration above, the sealing member prevents a contaminant such as moisture or the like from being transmitted into the liquid crystal layer from the outside air through the organic film. Therefore, it is possible to prevent the reliability of the liquid crystal display device from lowering due to the transmittance of the contaminant into the liquid crystal layer.

Furthermore, the present invention also applies to a method of manufacturing the liquid crystal display device according to any one of the first to fourth inventions.

Thus, a method according to the present invention includes the following steps: a first substrate manufacturing step in which the first substrate is manufactured; a second substrate manufacturing step in which the second substrate is manufactured; an alignment film forming step in which the alignment films are formed on surfaces of the first substrate and the second substrate, respectively; a sealing member forming step in which the sealing member is formed in an outer peripheral portion of the first substrate or the second substrate so as to surround the inside; and an attaching step in which the first substrate and the second substrate are attached to each other through the sealing member to encapsulate a liquid crystal layer in a hermetically sealed space inside the sealing member. In the alignment film forming step, the alignment films are formed such that outer peripheral edges are located inside the outer peripheral edges of the substrates with respect to the surfaces of the first substrate and the second substrate and that the notch or the opening is provided in the outer peripheral portion of at least one of the alignment films. In the sealing member forming step, the sealing member is formed so as to closely follow the outer peripheral portion of the alignment film and to be flattened when the first substrate and the second substrate are attached to each other to straddle the substrates and the alignment films, thereby covering the notch or the opening.

According to the manufacturing method above, the sealing member is not formed directly on the surfaces of the alignment films, which are likely to repel the sealing member. Therefore, it is possible to form the sealing member in a desired linear shape without accidently breaking it, and a normal sealing width can be obtained in a simple manner. Because of this, the hermetically sealed state of the space inside the sealing member is not damaged during the attaching step, and it becomes possible to encapsulate the liquid crystal layer between the first substrate and the second substrate in a secure manner.

Furthermore, when the first substrate and the second substrate are attached to each other in the attaching step, the sealing member is flattened, and spreads in the widthwise direction. This way, a portion of the sealing member overlaps an outer peripheral portion of the adjacent alignment film, thereby making it possible to cover the notch or the opening using the sealing member in a simple manner.

Further, the liquid crystal display devices according to the first to fourth inventions can be manufactured by this method. Thus, it is possible to prevent the foreign substances attached to the substrate surfaces from floating into the liquid crystal layer and to secure sufficiently high adhesion strength between the sealing member and the substrates. Further, the margin (margin region) in the alignment film formation location increases, and it is possible to stabilize the quality of the liquid crystal display device having a narrow frame configuration.

### EFFECTS OF THE INVENTION

According to the present invention, the sealing member straddles both of the substrates and both of the alignment films to cover the notch or the opening formed in at least one of the alignment films. Because of this, it is possible to prevent the foreign substances attached to the surfaces of the substrates from floating into the liquid crystal layer, and it is possible to secure sufficiently high adhesion strength between the sealing member and the substrates. As a result, it is possible to improve the display quality and to achieve highly reliable adhesion strength.

### BRIEF DESCRIPTION OF THE DRAWINGS

FIG. 1 is a plan view schematically showing a liquid crystal display device according to an embodiment.

FIG. 2 is a cross-sectional view along the line II-II in FIG. 1.

FIG. 3 is a plan view showing an overlapping portion of a sealing member and an alignment film according to an embodiment.

FIG. 4 is a plan view showing a TFT substrate on which an alignment film is formed in an alignment film forming step.

FIG. 5 is a plan view showing a TFT substrate on which a sealing member is formed in a sealing member forming step.

FIG. 6 is a cross-sectional view of a portion corresponding to FIG. 2 showing a TFT substrate on which a sealing member is formed in a sealing member forming step.

FIG. 7 is a plan view of a portion corresponding to FIG. 3 showing a sealing member formed in a sealing member forming step and an alignment film.

FIG. 8 is a cross-sectional view of a portion corresponding to FIG. 2 showing how to attach a TFT substrate to a CF substrate during an attaching step.

FIG. 9 is a cross-sectional view of a portion corresponding to FIG. 2 showing an attached body in which a TFT substrate and a CF substrate are attached to each other in an attaching step.

FIG. 10 is a drawing corresponding to FIG. 3 showing modification examples 1 of a liquid crystal display device according to embodiments.

FIG. 11 is a drawing corresponding to FIG. 2 showing a modification example 2 of a liquid crystal display device according to an embodiment.

### DETAILED DESCRIPTION OF EMBODIMENTS

Embodiments of the present invention are described below in detail with reference to figures. Here, the present invention is not limited to the respective embodiments below.

### Embodiments of the Invention

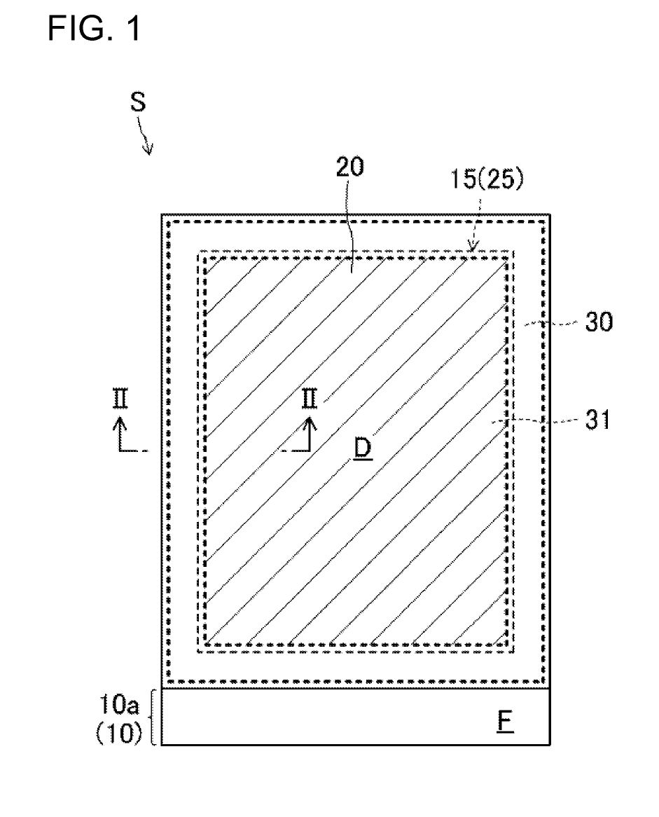

FIG. 1 is a schematic plan view of a liquid crystal display device S according to this embodiment.

The liquid crystal display device S has the following configuration. A TFT (Thin Film Transistor) substrate 10 that is a first substrate and a CF (Color Filter) substrate 20 that is a second substrate are disposed so as to face each other. Outer peripheral portions of the TFT substrate 10 and the CF substrate 20 are attached to each other by a sealing member 30 that is located between the outer peripheral portions of the substrates 10 and 20. A liquid crystal layer 31 is encapsulated in a hermetically sealed space inside the sealing member 30 between the TFT substrate 10 and the CF substrate 20.

The TFT substrate 10 and the CF substrate 20 are formed in rectangular shapes of substantially the same size, for example. One side of the TFT substance 10 (lower side in FIG. 1) protrudes from the CF substrate 20. The sealing member 30 is made of epoxy resin, for example, and is formed in a rectangular shape. The liquid crystal layer 31 is formed of a nematic liquid crystal material having electro-optic characteristics or the like.

Furthermore, in the liquid crystal display device S, a display region D that displays an image is set in a region in which the TFT substrate 10 and the CF substrate 20 overlap each other inside the sealing member 30, i.e., the region where the liquid crystal layer 31 is provided. A frame region F that is a non-display region is set outside the display region D. The display region D is a region in a rectangular shape, for example, and is formed of a plurality of pixels, which are the smallest units of an image, arranged in a matrix. On the other hand, the frame region F has a mounting region 10a that is a portion of the TFT substrate 10 protruding from the CF substrate 20. In the mounting region 10a, an IC (Integrated Circuit) chip, a wiring substrate (not shown in the figure), and the like are mounted.

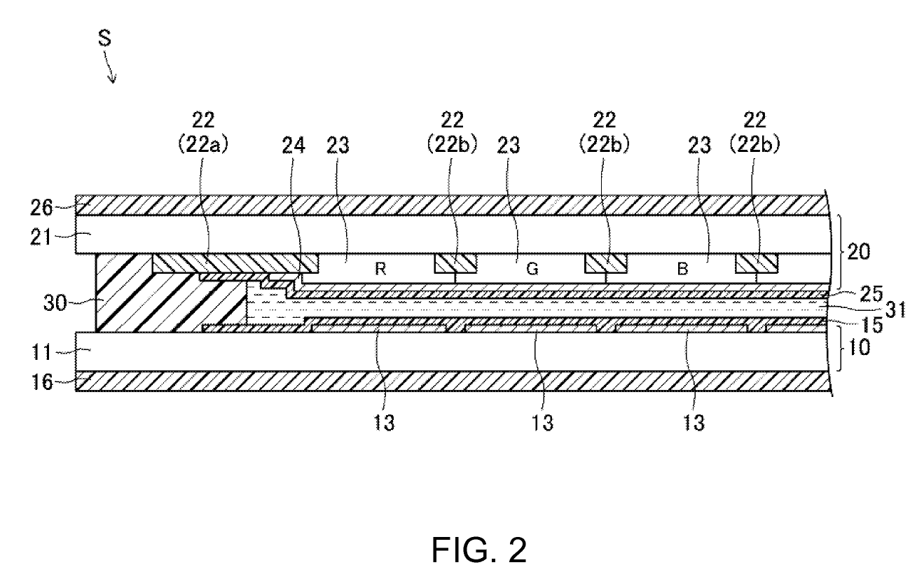

FIG. 2 shows a schematic cross-sectional view of the liquid crystal display device S along the line II-II in FIG. 1.

In the display region D, the TFT substrate 10 has a plurality of display wiring lines (not shown in the figure) constituted of gate wiring lines and source wiring lines that are provided in a grid pattern demarcating the respective pixels on an insulating substrate 11 through a gate insulating film, TFTs and storage capacitance elements (not shown in the figure) provided at the respective intersections of the plurality of the display wiring lines, i.e., in the respective pixels, and a protection film (not shown in the figure) provided so as to cover the respective TFTs. On the protection film, pixel electrodes 13 shown in FIG. 2 are provided in the respective pixels. The respective pixel electrodes 13 are connected to the TFTs through contact holes formed in the protection film.

The CF substrate 20 has, on an insulating substrate 21, a black matrix 22 formed of resin that is an organic film having an external frame 22a in a frame shape and grids 22b in a grid pattern corresponding to the display wiring lines inside the external frame 22a, color filters 23 in a plurality of colors including a red layer (R), a green layer (G), and a blue layer (b) that are respectively provided so as to be periodically arranged between the grids of the black matrix 22, a common electrode 24 provided so as to cover the black matrix 22 and the respective color filters 23, and a photo spacer (not shown in the figure) provided in a columnar shape on the common electrode 24.

Here, between the color filters 23 and the common electrode 24, an overcoat layer formed of epoxy-acrylate resin or the like may be provided for preventing a contaminant from entering the liquid crystal layer 31 from the color filter layers 23 and for planarization.

The TFT substrate 10 and the CF substrate 20 have alignment films 15 and 25, respectively, on surfaces on the liquid crystal layer 31 side. On the opposite surfaces from the liquid crystal layer 31, polarizing plates 16 and 26 are provided, respectively. The alignment film 15 on the TFT substrate 10 is formed so as to cover the respective pixel electrodes 13. The alignment film 25 on the CF substrate 20 is formed so as to cover the common electrode 24. The outer peripheral edges of the alignment films 15 and 25 on the substrates 10 and 20 are located inside the outer peripheral edges of the substrates 10 and 20, and in the outer peripheral portions of the respective substrates 10 and 20, the substrate surfaces are exposed from the respective alignment films 15 and 25. The outer peripheral portion of the alignment film 25 on the CF substrate 20 is located on the external frame 22a of the black matrix 22, and a portion of the external frame 22a is exposed from the alignment film 25.

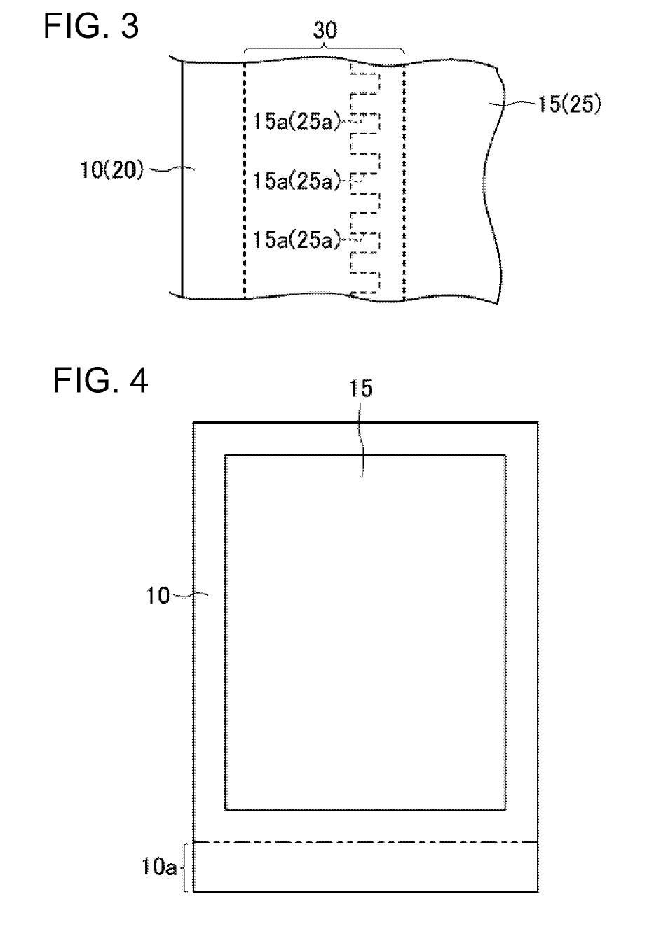

FIG. 3 shows a schematic plan view of an overlapping portion of the sealing member 30 and the alignment films 15 and 25. Here, in the present embodiment, an overlapping portion of the alignment film 15 on the TFT substrate 10 and the sealing member 30 and an overlapping portion of the alignment film 25 on the CF substrate 20 and the sealing member 30 have the same configuration. Thus, in FIG. 3, the former is shown to represent both of them, and the latter is shown in parentheses.

In the outer peripheral portions of the respective alignment films 15 and 25, notches 15a and 25a in rectangular comb shapes are formed throughout the entire circumferences. The sealing member 30 is formed to straddle the surfaces of the TFT substrate 10 and the CF substrate 20 and the alignment films 15 and 25 on the substrates 10 and 20. The notches 15a and 25a of the alignment films 15 and 25 are covered by the sealing member 30. The overlapping area of the alignment films 15 and 25 with respect to the sealing member 30 is an area that is 30% or less of the entire area of the sealing member 30. Even when foreign substances are left on the surfaces of the TFT substrate 10 and the CF substrate 20, it is possible to prevent the foreign substances from floating into the liquid crystal layer 31 by overlapping the sealing member 30 and the alignment films 15 and 25 this way. Furthermore, it is possible to secure sufficiently high adhesion strength between the sealing member 30 and the substrates 10 and 20.

Thus, because the sealing member 30 partially overlaps the alignment films 15 and 25, the surfaces of the TFT substrate 10 and the CF substrate 20 are not exposed between the sealing member 30 and the alignment films 15 and 25. Even when the foreign substances attached to the substrates when manufacturing the substrates are left on surfaces of the respective substrates 10 and 20, it is possible to prevent the foreign substances from floating into the liquid crystal layer 31. Further, the notches 15a and 25a are formed in the portions of the alignment films overlapping the sealing member 30. The overlapping areas of the sealing member 30 and the alignment films 15 and 25 are reduced by this amount. On the other hand, the contact areas between the sealing member 30 and the surfaces of the respective substrates 10 and 20 increase corresponding to the size of areas of the sealing member 30 that are in contact with the TFT substrate 10 and the CF substrate 20 through the notches 15a and 25a, and an area portion of at least 70% or more of the entire sealing member 30 is directly formed on the surfaces of the respective substrates 10 and 20. Therefore, it is possible to secure the adhesion strength between the sealing member 30 and the alignment films 15 and 25 to be as high as possible when the sealing member 30 partially overlaps the alignment films 15 and 25. As a result, it is possible to achieve the liquid crystal display device S having improved display quality and highly reliable adhesion strength between the sealing member 30 and the substrates 10 and 20 in which the substrates 10 and 20 are attached to each other in a secure manner.

Further, even if the respective alignment films 15, 25, or the sealing member 30 is formed at a location that is shifted from the location at which it was to be formed, the overlapping areas of the respective alignment films 15 and 25 with respect to the entire sealing member 30 can be within a prescribed area range that can secure the necessary adhesion strength for the sealing member 30 and the respective substrates 10 and 20. As a result, the margins (margin regions) of the formation locations of the respective alignment films 15 and 25 increase, and it becomes possible to stabilize the quality in the liquid crystal display device S having a narrow frame configuration as well.

It would be difficult to achieve this structure by making the widths of the overlapping portions narrower because it would be difficult to control the overlapping portions of the sealing member 30 and the respective alignment films 15 and 25 in such an arrangement. However, according to the present embodiment, the contact areas between the sealing member 30 and the surfaces of the respective substrates 10 and 20 are increased through the notches 15a and 25a formed in the respective alignment films 15 and 25. As a result, the configuration can be achieved in a simple manner while securing relatively large overlapping portions between the sealing member 30 and the respective alignment films 15 and 25.

Furthermore, on the CF substrate 20, the external frame 22a of the black matrix 22 exposed from the alignment film 25 is covered by the sealing member 30. This way, the sealing member 30 can prevent a contaminant such as moisture or the like from being transmitted into the liquid crystal layer 31 from the outside air through the black matrix 22. As a result, it is possible to prevent the reliability of the liquid crystal display device S from lowering due to transmission of the contaminant into the liquid crystal layer 31.

Here, when the overcoat layer is provided on the CF substrate 20 as described above and the overcoat layer is exposed from the alignment film 25 in the outer peripheral portion of the CF substrate 20, the overcoat layer portion exposed from the alignment film 25 preferably is covered by the sealing member 30 from a standpoint of preventing a contaminant such as moisture or the like from being transmitted into the liquid crystal layer 31 through the overcoat layer.

In the liquid crystal display device S having the configuration above, the TFTs are turned on through the display wiring lines in the respective pixels, and a prescribed electric charge is written into the pixel electrodes 13 through the TFTs. This way, a difference in potential occurs between the pixel electrodes 13 and the common electrode 24, and a prescribed voltage is applied to the liquid crystal layer 31. When the TFTs are turned off, a change in potential of the pixel electrodes 13 is suppressed by a storage capacitance stored in the storage capacitance elements. Further, in the liquid crystal display device S, an orientation state of the liquid crystal molecules set by the respective alignment films 15 and 25 is changed in the respective pixels by the size of voltages applied to the liquid crystal layer 31 to adjust the transmittance of light of the liquid crystal layer 31 in order to display a desired image.

Manufacturing Method

Next, a method of manufacturing the above-mentioned liquid crystal display device S is described with reference to FIGS. 4 to 9 using an example. Here, in the present embodiment, a single wafer manufacturing method in which the TFT substrate 10 and the CF substrate 20 are manufactured individually and in which the substrates 10 and 20 are attached to each other to manufacture a single liquid crystal display device S is described as an example. However, the present invention may be applied in a multiple surface manufacturing method in which a plurality of cell units are formed at the same time.

The method of manufacturing the liquid crystal display device S includes a TFT substrate manufacturing step, a CF substrate manufacturing step, an alignment film forming step, a sealing member forming step, and an attaching step.

TFT Substrate Manufacturing Step

An insulating substrate 11 such as a glass substrate or the like is prepared. On the insulating substrate 11, a film forming treatment such as a sputtering method, a CVD (Chemical Vapor Deposition) method, or the like, and a patterning treatment such as photolithography or the like are performed repeatedly to form display wiring lines, a gate insulating film, TFTs, storage capacitance elements, a protection film, and the pixel electrodes 13. The TFT substrate 10 is manufactured this way.

CF Substrate Manufacturing Step

First, an insulating substrate 21 such as a glass substrate or the like is prepared. On the insulating substrate 21, an application treatment of photosensitive resin by a spin coating method, a slit coating method, or the like and a patterning treatment by exposure and development of the photosensitive resin are repeatedly performed to form the black matrix 22 and the color filters 23 of the respective colors. Next, the common electrode 24 is formed by a sputtering method. Then, an application treatment of photosensitive resin by the spin coating method and a patterning treatment by exposure and development of the photosensitive resin are performed to form a photo spacer. The CF substrate 20 is manufactured this way.

Alignment Film Forming Step

First, a solution into which polyimide resin was added as a solvent is applied on a surface of the TFT substrate 10 by a printing method. The alignment film 15 having a prescribed film thickness is formed as shown in FIG. 4 by baking the applied solution to evaporate the solvent component. Next, a cloth called a rubbing cloth is slid on the alignment film 15 on the TFT substrate 10 in a prescribed direction to give the alignment film 15 an alignment function that aligns the liquid crystal molecules in one direction.

Furthermore, a solution into which polyimide resin was added as a solvent is also applied on a surface of the CF substrate 20 by a printing method. The alignment film 25 having a prescribed film thickness is formed by baking the applied solution to evaporate the solvent component. The rubbing cloth is also slid on the alignment film 25 on the CF substrate 20 in a prescribed direction to give the alignment film 25 an alignment function.

Here, when manufacturing the liquid crystal display device S of a VA (Vertically Aligned) mode in which the alignment films 15 and 25 are vertical alignment films and the like, for example, the rubbing treatment to slide the rubbing cloth described above may not be performed.

Sealing Member Forming Step

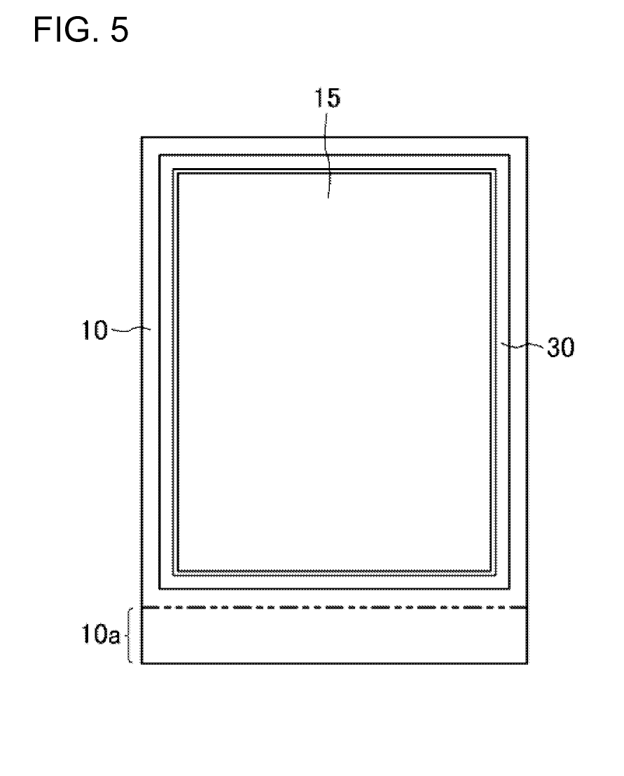

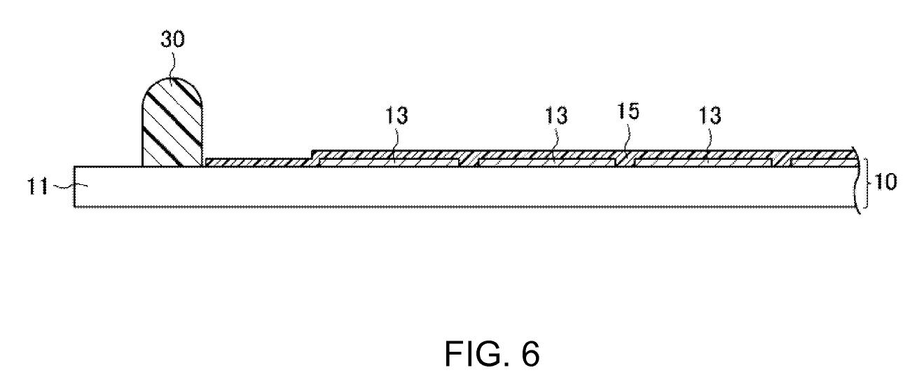

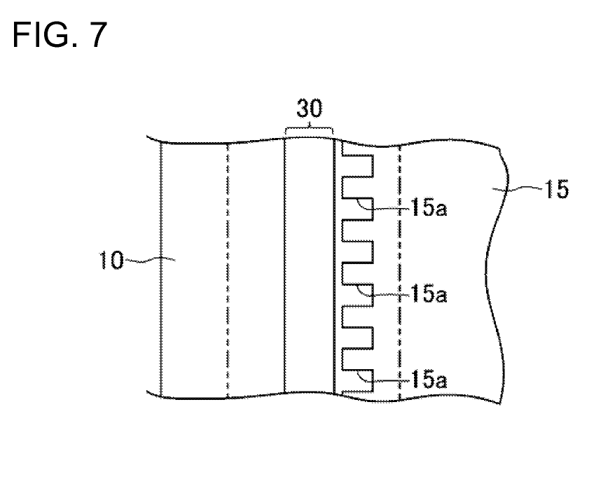

As shown in FIG. 5, the sealing member 30 formed of ultraviolet curable epoxy resin is formed in a rectangular frame shape that surrounds the alignment film 15 inside with respect to the outer peripheral portion of the TFT substrate 10 using a dispenser or a screen printing method. As shown in FIGS. 6 and 7, at this time, the sealing member 30 and the alignment film 15 do not overlap each other, and the sealing member 30 is formed so as to closely follow the outer peripheral portion of the alignment film 15. The double-dashed lines in FIG. 7 show a formation region of the sealing member 30 corresponding to FIG. 3. In this step, the sealing member 30 is not formed directly on the surface of the alignment film 15 that is likely to repel the sealing member 30. Because of this, it is possible to form the sealing member 30 in a desired linear shape without accidently breaking it. Thus, a normal sealing width can be obtained in a simple manner.

Here, in the present embodiment, the sealing member 30 is formed on the TFT substrate 10. However, the sealing member 30 may be formed on the CF substrate 20. Further, a sealing member that is both ultraviolet curable and thermosetting may be used as the sealing member 30.

Attaching Step

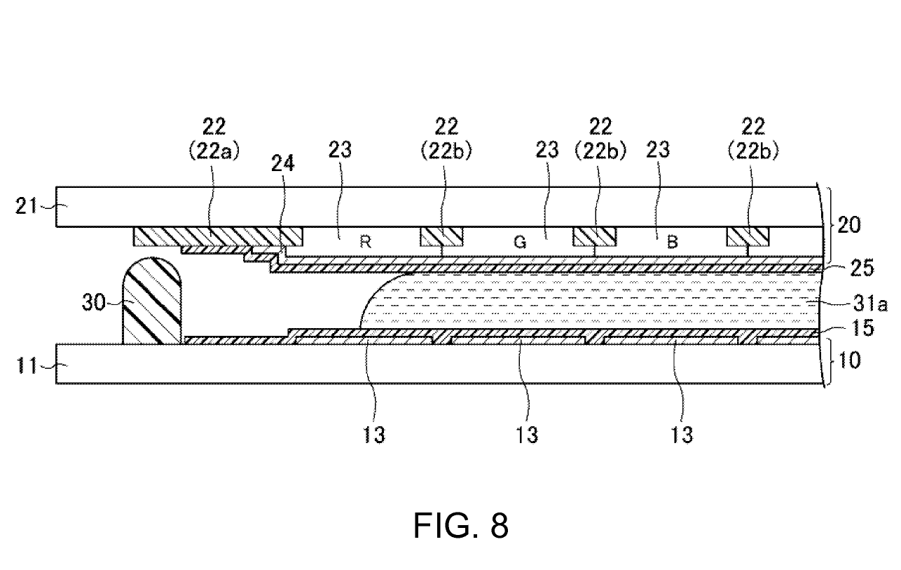

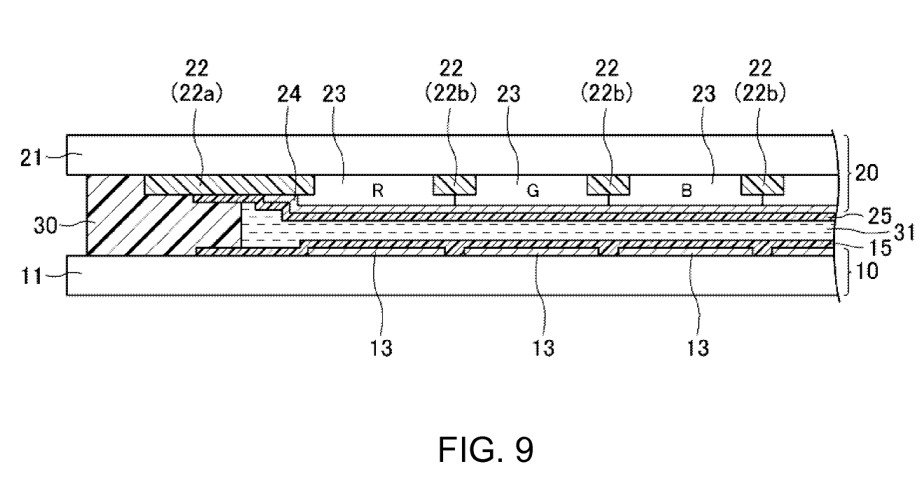

In a region on the TFT substrate 10 surrounded by the sealing member 30, a liquid crystal material 31a of a prescribed amount is dripped by a dispenser. Next, as shown in FIG. 8, the TFT substrate 10 and the CF substrate 20 are attached to each other with the sealing member 30 therebetween in a vacuum environment, and the sealing member 30 is cured by irradiating it with ultraviolet light to adhere the TFT substrate 10 to the CF substrate 20. The liquid crystal layer 31 is encapsulated in a hermetically sealed space formed between the substrates 10 and 20 by the sealing member 30. At this time, when the TFT substrate 10 and the CF substrate 20 are attached to each other, the sealing member 30 is flattened, and is formed to straddle the surfaces of the substrates 10 and 20 and the alignment films 15 and 25 as shown in FIG. 9. As a result, the notches 15a and 25a of the alignment films 15 and 25 are covered by the sealing member 30. Further, because the sealing member 30 having a normal line width is formed in the sealing member forming step described above, the hermetically sealed state of the space inside the sealing member 30 is not damaged, and the liquid crystal layer 31 can be encapsulated between the TFT substrate 10 and the CF substrate 20 in a secure manner.

Here, in the present embodiment, the liquid crystal layer 31 is encapsulated between the substrates 10 and 20 by a so-called drip injection method in which the sealing member 30 is formed in a frame shape; the liquid crystal material 31a is dripped on the substrate surface inside the sealing member 30; and the TFT substrate 10 and the CF substrate 20 are attached to each other. However, the liquid crystal layer 31 may be encapsulated between the substrates 10 and 20 by a so-called vacuum injection method in which the sealing member is substantially formed in a frame shape having a slit; the TFT substrate 10 and the CF substrate 20 are attached to each other; the liquid crystal material 31a is injected inside the sealing member between the substrates 10 and 20 from an inlet that is constituted of the slit in the sealing member using a difference in atmospheric pressure by vacuuming; and the inlet is sealed by a sealant.

Then, the polarizing plates 16 and 26 are respectively attached to both surfaces of the attached body of the TFT substrate 10 and the CF substrate 20. Next, an IC chip and a wiring substrate are mounted on the mounting region 10a of the TFT substrate 10 through an ACF (Anisotropic Conductive Film) by thermal compression.

The liquid crystal display device S can be manufactured by performing the steps above.

### Modification Example 1 of Embodiment

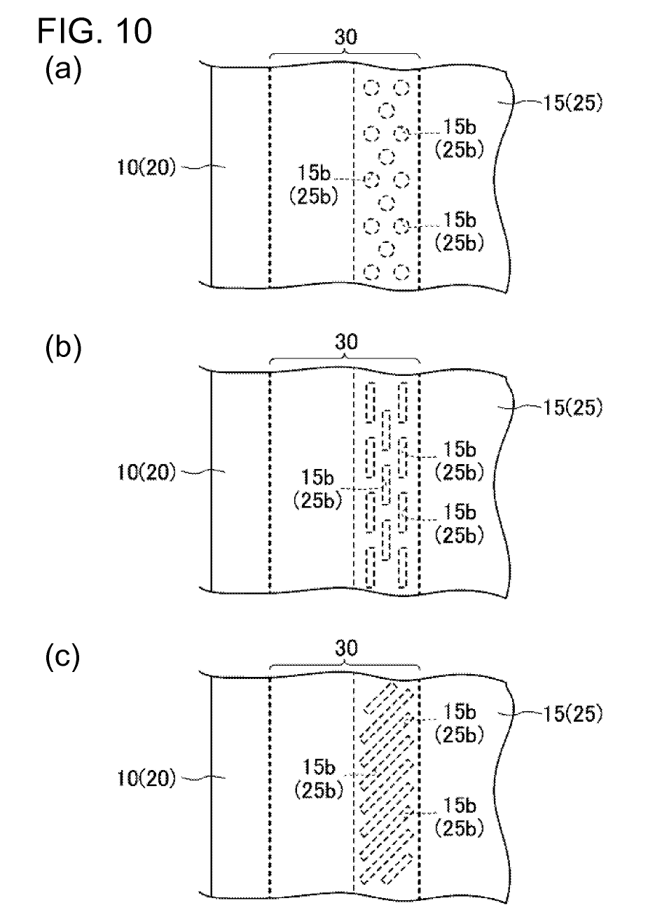

FIG. 10 is a drawing corresponding to FIG. 2 showing main portions of the alignment films 15 and 25 of a liquid crystal display device S according to modification examples 1 of this embodiment. The modification examples 1 are configured in a manner similar to that of the embodiment described above except that the alignment films 15 and 25 are configured differently from the embodiment described above. Therefore, only the alignment films 15 and 25 having different configurations are described. Here, in the modification examples below, components that are the same as those in FIGS. 1 to 9 are given the same reference characters, and their description are to be referred to the description of the embodiment described above. Their description in detail is omitted.

In the embodiment described above, the notches 15a and 25a in rectangular comb shapes were formed in the outer peripheral portions of the respective alignment films 15 and 25. However, as shown in FIG. 10(a), in this modification example, openings 15b and 25b in circular shapes in a plan view are formed in a zigzag pattern along the entire circumferences of the outer peripheral portions of the alignment films 15 and 25, respectively. Further, the sealing member 30 is formed to straddle the surfaces of the TFT substrate 10 and the CF substrate 20, as well as the alignment films 15 and 25 on the substrates 10 and 20, and the openings 15b and 25b of the alignment films 15 and 25 are covered by the sealing member 30. The overlapping area of the alignment films 15 and 25 with respect to the sealing member 30 is an area that is 30% or less of the entire area of the sealing member 30 in the same manner as the above-mentioned embodiment.

Here, in the present modification example, the openings 15b and 25b formed in the respective alignment films 15 and 25 are in circular shapes. However, the present invention is not limited thereto. As shown in FIG. 10(b), the openings 15b and 25b formed in the respective alignment films 15 and 25 may be formed in rectangular slit shapes in a plan view. Alternatively, as shown in FIG. 10(c), the openings 15b and 25b in rectangular slit shapes may be formed so as to extend diagonally with respect to the widthwise direction of the sealing member.

According to the configuration of the modification example 1, the sealing member 30 also overlaps the alignment films 15 and 25 partially. Because of this, it is possible to prevent foreign substances that attached to the surfaces of the TFT substrate 10 and the CF substrate 20 when the substrates are manufactured from floating into the liquid crystal layer 31. Furthermore, because an area portion of at least 70% or more of the sealing member 30 is formed directly on the surfaces of the respective substrates 10 and 20, it is possible to secure sufficiently high adhesion strength between the sealing member 30 and the substrates 10 and 20. As a result, it is possible to achieve the liquid crystal display device S in which the display quality is improved and in which the substrates 10 and 20 are attached to each other in a secure manner. Further, the same functional effects as the above-mentioned embodiment can be obtained in other aspects.

### Modification Example 2 of Embodiment

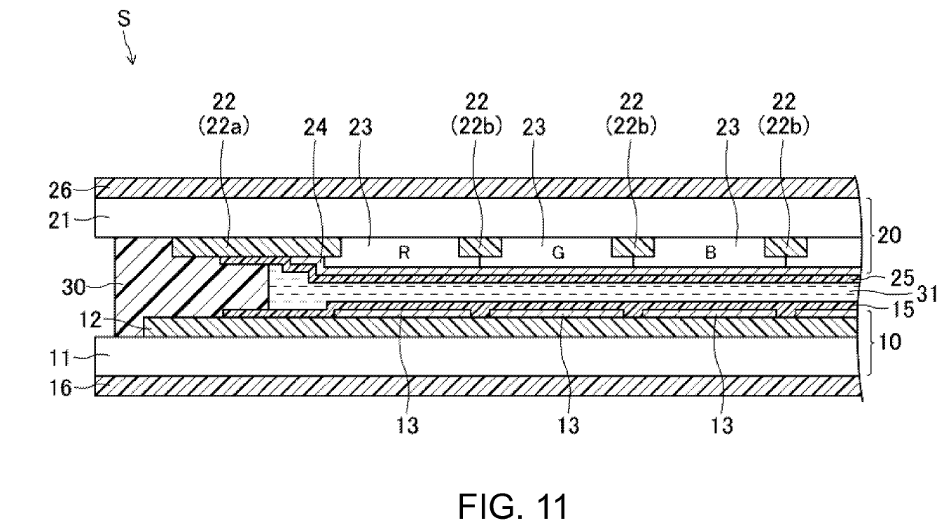

FIG. 11 is a drawing corresponding to FIG. 2 showing a liquid crystal display device S according to a modification example 2 of the embodiment. The modification example 2 is configured in a manner similar to that of the above-mentioned embodiment except that the TFT substrate 10 is configured differently from the above-mentioned embodiment.

As shown in FIG. 11, the TFT substrate 10 according to the present modification example has a so-called FSP (Field Shield Pixel) configuration in which the respective TFTs are covered by an insulating planarization film 12 that is an acrylic organic resin film and in which the respective pixel electrodes 13 are formed on the insulating planarization film 12. According to this FSP configuration, the respective pixel electrodes 13 can be disposed so as to overlap the display wiring lines, and the regions of the respective pixel electrodes 13 can be increased. As a result, the aperture ratios of the respective pixels can be increased.

The insulating planarization film 12 is exposed from the alignment film 15 in the outer peripheral portion of the TFT substrate 10. The insulating planarization film portion exposed from the alignment film 15 is covered by the sealing member 30. This way, the sealing member 30 can prevent a contaminant such as moisture or the like from being transmitted into the liquid crystal layer 31 from the outside air through the insulating planarization film 12. Because of this, it is possible to prevent the reliability of the liquid crystal display device S from lowering due to transmission of the contaminant into the liquid crystal layer 31 while increasing the aperture ratios of the respective pixels. Further, the same function effects as the above-mentioned embodiment can be obtained in other aspects.

### Other Embodiments

In the above-mentioned embodiments, the notches 15a and 25a or the openings 15b and 25b were formed in the outer peripheral portions of the alignment films 15 and 25 on the TFT substrate 10 and the CF substrate 20. However, the present invention is not limited thereto, and it is sufficient if the notches 15a or 25a or the openings 15b or 25b are formed in at least one of the alignment films 15 and 25.

Therefore, the notches 15a or the openings 15b may be formed only in the alignment film 15 on the TFT substrate 10. In this configuration, the sealing member 30 is brought into contact with a surface of the TFT substrate 10 through the notches 15a or the openings 15b. Because of this, sufficient adhesion strength can be secured between the sealing member 30 and the TFT substrate 10. Alternatively, the notches 25a or the openings 25b may be formed only in the alignment film 25 on the CF substrate 20. In this configuration, the sealing member 30 is brought into contact with a surface of the CF substrate 20 through the notches 25a or the openings 25b. As a result, sufficient adhesion strength can be secured between the sealing member 30 and the CF substrate 20.

Preferred embodiments of the present invention were described above. However, the technical scope of the present invention is not limited to the scope described in the above-mentioned embodiments. The embodiments described above are examples. It is understood by a person skilled in the art that various types of additional modification examples are possible in terms of combining the respective components and the respective treatment processes and that these modification examples are also included in the scope of the present invention.

### INDUSTRIAL APPLICABILITY

As described above, the present invention is useful in a liquid crystal display device and a manufacturing method thereof. Particularly, the present invention is suitable for a liquid crystal display device in which a foreign substance attached to a substrate surface needs to be prevented from floating into a liquid crystal layer and in which sufficiently high adhesion strength needs to be obtained between a sealing member and a substrate and for a manufacturing method thereof.

### DESCRIPTION OF REFERENCE CHARACTERS

S liquid crystal display device
TFT substrate (first substrate)
12 insulating planarization film (organic film)
15, 25 alignment films
15a, 25a notches
15b, 25b openings
20 CF substrate (second substrate)
22 black matrix (organic film)
30 sealing member

1. A liquid crystal display device, comprising:
a first substrate and a second substrate that are disposed so as to face each other and that have alignment films provided on their respective surfaces facing each other;
a sealing member that is located between outer peripheral portions of said first substrate and said second substrate to attach the outer peripheral portions to each other and that forms a hermetically sealed space inside; and
a liquid crystal layer encapsulated in said hermetically sealed space,
wherein outer peripheral edges of the alignment films on said first substrate and said second substrate are located inside outer peripheral edges of said substrates, and a notch or an opening is formed in an outer peripheral portion of at least one of said alignment films, and
wherein said sealing member straddles said substrates and said alignment films to cover said notch or opening.

2. The liquid crystal display device according to claim 1, wherein said notch or opening is formed in the outer peripheral portions of said alignment films.

3. The liquid crystal display device according to claim 1, wherein an overlapping area of said alignment film having the notch or the opening and said sealing member is an area that is 30% or less of an entire area of said sealing member.

4. The liquid crystal display device according to claim 1, wherein on at least one of said first substrate and said second substrate, an organic film that is exposed from said alignment film in the outer peripheral portion is provided on a liquid crystal layer side, and
wherein said sealing member is formed so as to cover said organic film portion exposed from said alignment film.

5. A method of manufacturing a liquid crystal display device that is a method of manufacturing the liquid crystal display device according to claim 1, the method comprising:
a first substrate manufacturing step of manufacturing said first substrate;
a second substrate manufacturing step of manufacturing said second substrate;
an alignment film forming step of forming said alignment films respectively on surfaces of said first substrate and said second substrate;
a sealing member forming step of forming said sealing member in an outer peripheral portion of said first substrate or said second substrate so as to surround the inside;
an attaching step of attaching said first substrate and said second substrate to each other through said sealing member to encapsulate a liquid crystal in a hermetically sealed space inside said sealing member,
wherein in said alignment film forming step, said alignment films are formed such that the outer peripheral edges are located inside the outer peripheral edges of said substrates with respect to surfaces of said first substrate and said second substrate and that said notch or opening is provided in the outer peripheral portion of at least one of the alignment films, and
wherein in said sealing member forming step, said sealing member is formed so as to closely follow the outer peripheral portions of said alignment films and to be flattened when said first substrate and said second substrate are attached to each other to straddle said substrates and said alignment films to cover said notch or opening.
